(19) United States
(12) Patent Application Publication
(10) Pub. No.: US 2012/0192088 A1
(43) Pub. Date: Jul. 26, 2012

(54) METHOD AND SYSTEM FOR PHYSICAL MAPPING IN A VIRTUAL WORLD

(75) Inventors: Nicholas SAURIOL, Ottawa (CA); Arn HYNDMAN, Ottawa (CA); Paul TO, Menlo Park, CA (US)

(73) Assignee: Avaya Inc., Basking Ridge, NJ (US)

(21) Appl. No.: 13/010,251

(22) Filed: Jan. 20, 2011

(51) Int. Cl. G06F 3/048

(52) U.S. Cl. 715/757

(57) ABSTRACT

A method and system for capturing user actions in the real world and mapping the users, their actions, and their avatars into a three dimensional virtual environment. Data representing real world users are captured, collected and sent to a virtual proxy bridge, which transforms the data into control signal for avatars, which are then mapped to the virtual environment. The real world avatars move around in parallel with the users in the real world via the use of data capture devices such as radio frequency identification (“RFID”) readers, triangulation or global positioning satellite (“GPS”) systems, and cameras. Real world users can therefore be represented as virtual users, thus removing the distinction between real world users and virtual environment users.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to virtual environments and more particularly to a method and system for mapping users in the real world into a virtual world without requiring the users to consciously interact with the virtual world.

### BACKGROUND OF THE INVENTION

Virtual environments simulate actual or fantasy three dimensional (“3D”) environments and allow for users to interact with each other and with constructs in the environment via remotely-located clients. One context in which a virtual environment may be used is in the business world where some meeting participants are remotely located yet need to interact with the participants at the actual meeting site.

In a virtual environment, a universe is simulated within a computer processor/memory. Multiple people may participate in the virtual environment through a computer network, e.g., a local area network or a wide area network such as the Internet. Each participant in the universe selects an “avatar” to represent them in the virtual environment. The avatar is often a 3D representation of a person or other object. Participants send commands to a virtual environment server that controls the virtual environment thereby causing their avatars to move and interact within the virtual environment. In this way, the participants are able to cause their avatars to interact with other avatars and other objects in the virtual environment.

A virtual environment often takes the form of a virtual-reality 3D map, and may include rooms, outdoor areas, and other representations of environments commonly experienced in the physical world. The virtual environment may also include multiple objects, people, animals, robots, avatars, robot avatars, spatial elements, and objects/environments that allow avatars to participate in activities. Participants establish a presence in the virtual environment via a virtual environment client on their computer, through which they can create an avatar and then cause the avatar to “live” within the virtual environment.

As the avatar moves within the virtual environment, the view experienced by the avatar changes according to where the avatar is located within the virtual environment. The views may be displayed to the participant so that the participant controlling the avatar may see what the avatar is seeing. Additionally, many virtual environments enable the participant to toggle to a different point of view, such as from a vantage point outside (i.e. behind) the avatar, to see where the avatar is in the virtual environment.

The participant may control the avatar using conventional input devices, such as a computer mouse and keyboard or optionally may use a more specialized controller. The inputs are sent to the virtual environment client, which forwards the commands to one or more virtual environment servers that are controlling the virtual environment and providing a representation of the virtual environment to the participant via a display associated with the participant's computer.

Depending on how the virtual environment is set up, an avatar may be able to observe the environment and optionally also interact with other avatars, modeled objects within the virtual environment, robotic objects within the virtual environment, or the environment itself, i.e. an avatar may be allowed to go for a swim in a lake or river in the virtual environment. In these cases, client control input may be permitted to cause changes in the modeled objects, such as moving other objects, opening doors, and so forth, which optionally may then be experienced by other avatars within the virtual environment.

“Interaction” by an avatar with another modeled object in a virtual environment means that the virtual environment server simulates an interaction in the modeled environment in response to receiving client control input for the avatar. Interactions by one avatar with any other avatar, object, the environment or automated or robotic avatars may, in some cases, result in outcomes that may affect or otherwise be observed or experienced by other avatars, objects, the environment, and automated or robotic avatars within the virtual environment.

A virtual environment may be created for the user, but more commonly the virtual environment may be persistent, in which it continues to exist and be supported by the virtual environment server even when the user is not interacting with the virtual environment. Thus, where there is more than one user of a virtual environment, the environment may continue to evolve when a user is not logged in, such that the next time the user enters the virtual environment it may be changed from what it looked like the previous time.

Virtual environments are commonly used in on-line gaming, such as for example in online role playing games where users assume the role of a character and take control over most of that character's actions. However, in addition to games, virtual environments are being used to simulate real life environments to provide an interface for users that will enable on-line education, training, shopping, and other types of interactions between groups of users and between businesses and users.

In a business setting, members of the virtual environment may wish to communicate and interact with users in their virtual environment, users in other virtual environments, and people in the real word environment. This is particularly applicable in the business world where “virtual” meetings have become very popular. In a virtual meeting, attendees, by the click of a button, can “enter” a conference room, view the surrounds, converse with real world participants and contribute their input to the meeting.

Existing technology requires that users in a real world meeting location be actively engaged with the controls of the virtual environment, such as a mouse or a keyboard. This means that if the user is giving a presentation, it is very difficult for them to interact with both a live audience (those physically located at the same site as the user), and a virtual audience, at the same time. However, there are instances where one wishes to interact with people who are both co-located and remotely located (and therefore “virtually” represented). There is currently no adequate system that allows the presenter to adequately communicate with other participants that are both co-located with the presenter, and those in a virtual environment.

Attempts to solve the afore-mentioned problem have not succeeded. For example, one attempted solution overlays one environment over the other. For example, displaying video in a 3D environment would give the virtual environment a live view of what is happening within the real world. However, the drawback is that live users and virtual users are represented differently thus creating a bias that may adversely affect collaboration between real world participants and those in the virtual environment. Further, video streaming into 3D environments from multiple sites is a bandwidth and processor intensive activity that does not scale well to large numbers of users.

Therefore, what is needed is a method and system that transparently maps users and user actions in the real world into a virtual 3D world without requiring the users in the real world to consciously interact with the virtual environment.

### SUMMARY OF THE INVENTION

The present invention advantageously provides a method and system for capturing user actions in the real world and mapping the users, their actions, and their avatars into a three dimensional virtual environment. Data representing real world users are captured, collected and sent to a virtual proxy bridge, which transforms the data into control signal for avatars, which are then mapped to the virtual environment. The real world avatars move around in parallel with the users in the real world via the use of data capture devices such as radio frequency identification (“RFID”) readers, triangulation or global positioning satellite (“GPS”) systems, and cameras. Real world users can therefore be represented as virtual users, thus removing the distinction between real world users and virtual environment users.

In one aspect of the invention, a method of mapping a real world user into a virtual environment is provided where the virtual environment includes a virtual environment user. The method includes identifying the real world user in a real world space, collecting real world position data from the real world user, mapping the real world position data onto the virtual environment, creating a mixed world environment that includes the real world user and the virtual environment user in the real world space, and displaying the virtual environment.

In another aspect, a system for mapping a real world user onto a virtual environment is provided, where the virtual environment includes a virtual environment user. The system includes a data collection module for identifying the real world user in a real world space and collecting real world position data from the real world user. The system also includes a virtual proxy bridge for receiving the real world position data from the data collection module and mapping the real world position data onto the virtual environment in order to create a mixed world environment that includes the real world user and the virtual environment user in the real world space.

In yet another aspect of the invention, a virtual proxy bridge for mapping a real world user onto a virtual environment, the virtual environment including a virtual environment user, is provided. The virtual proxy bridge includes a data interface receiving real world data, the real world data identifying real world user and the real world user's position in a real world space. The virtual proxy bridge also includes a data mapping module mapping the real world data onto the virtual environment to create an extended real world environment that includes the real world user and the virtual environment user in the real world space.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary system showing the interaction between a virtual environment and a real world environment in accordance with the principles of the present invention;

FIG. 2 is a diagram showing how local participants view remove participants in a mixed reality environment in accordance with the principles of the present invention;

FIG. 3 is a diagram showing how remote participants view all participants in a mixed reality environment in accordance with the principles of the present invention;

FIG. 4 is a flowchart illustrating an exemplary mixed reality world process performed by an embodiment of the present invention;

FIG. 5 is a diagram of an exemplary real world conference room layout with real world and virtual world participants in accordance with an embodiment of the present invention; and

FIG. 6 is a diagram illustrating how virtual a world presentation screen appears to real world participants in accordance with the present invention.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for mapping real world users into a virtual environment by providing a mixed reality world where virtual user avatars and real world user avatars are both represented on a viewing screen.

As used herein, relational terms, such as “first” and “second,” “top” and “bottom,” and the like, may be used solely to distinguish one entity or element from another entity or element without necessarily requiring or implying any physical or logical relationship or order between such entities or elements.

One embodiment of the present invention advantageously provides a method and system for capturing user actions in the real world and transparently mapping the users, their actions, and their avatars into a three dimensional (“3D”) virtual environment. Data representing real world users are captured, collected and sent to a virtual proxy bridge, which transforms the data into control signals for avatars, which are mapped to the virtual environment. Thus, real world users are represented by avatars, just as virtual world users are represented by their avatars. The real world avatars move around in parallel with the users in the real world via the use of data capture devices such as radio frequency identification (“RFID”) readers, triangulation or global positioning satellite (“GPS”) systems, and cameras. In this fashion, real world users can be represented as virtual users, thus removing the distinction between real world users and virtual environment users. Of note, although the present invention is generally described in the context of a many-to-many meeting room scenario, it is understood that the present invention is equally adapted for use within the context of an office of a single individual who may wish to have his/her real world presence represented virtually.

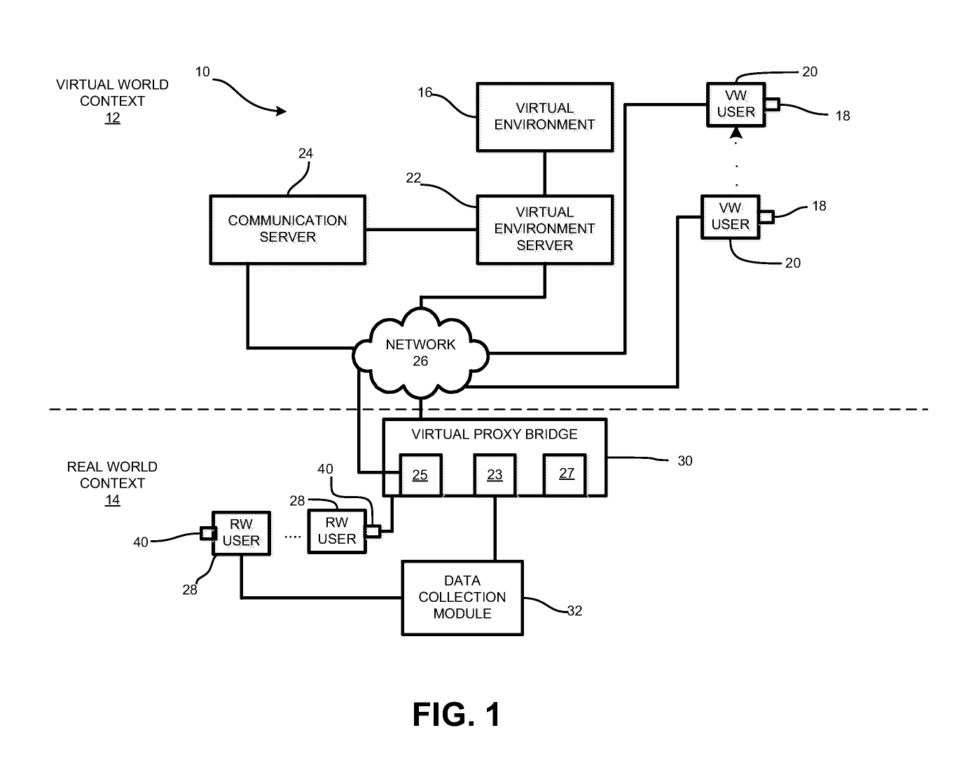

Referring now to the drawing figures in which like reference designators refer to like elements, there is shown in FIG. 1 an exemplary configuration of a real world user mapping system 10 constructed in accordance with the principles of the present invention. FIG. 1 illustrates a virtual world context 12 and a real world context 14. Virtual world context 12 includes a virtual environment 16 as well as other elements that enable virtual environment 16 to operate. Virtual environment 16 may be any type of virtual environment, such as a virtual environment created for an on-line game, a virtual environment created to implement an on-line store, a virtual environment created to implement a virtual conference, or for any other purpose. Virtual environment 16 can be created for many reasons, and may be designed to enable user interaction to achieve a particular purpose. Exemplary uses of virtual environments 16 include gaming, business, retail, training, social networking, and many other aspects. Generally, virtual environment 16 will have its own distinct 3D coordinate space.

Virtual world users 20 are users represented in virtual environment 16 via their avatar 18. Avatars 18 representing virtual world users 20 may move within the three 3D coordinate space and interact with objects and other avatars 18 within the 3D coordinate space of virtual world context 12. One or more virtual environment servers 22 maintain virtual environment 16 and generate a visual presentation for each virtual environment user 20 based on the location of the user's avatar 18 within virtual environment 16. Communication sessions such as audio calls and video interactions between virtual world users 20 may be implemented by one or more communication servers 24. A virtual world user 20 may access virtual environment 16 from their computer over a network 26 or other common communication infrastructure. Access to network 26 can be wired or wireless. Network 26 can be a packet network, such as a LAN and/or the Internet, or can use any suitable protocol. Each virtual world user 20 has access to a computer that may be used to access virtual environment 16. The computer will run a virtual environment client and a user interface in order to connect to virtual environment 16. The computer may include a communication client to enable the virtual world user 20 to communicate with other virtual world users 20 who are also participating in the 3D computer-generated virtual environment 16.

FIG. 1 also illustrates real world context 14 that includes one or more real world users 28. Each real world user 28 also wishes to be represented by their avatar 40 within virtual environment 16. In one embodiment, real world users 28 are users that are physically present within real world context 14, such as, for example, a business conference, where virtual users 20 also wish to be “present” at the conference. Because it is often cumbersome for a real world user 28 to interact with both other real world users 28 and virtual users 20, system 10 of the present invention physically maps real world users 28 and their mannerisms onto a 3D virtual environment 16 so that real world users 28 can interact with each conference participant without regard to whether they are actually physically present at the conference i.e., real world users 28, or remotely present, i.e., virtual world users 20.

In order to physically map real world users 28 into virtual environment 16, the location and orientation of real world users 28 in real world context 14 must first be determined. Data that identifies each real world user 28, his relative position in real world context 14 as well as other real world user related information is collected by data collection module 32 and transmitted to a virtual proxy bridge 30. Data collection module 32 may be a single, multi-purpose module or may include multiple data collection sub-modules, each operating to collect different types of data. For example, one data collection module could be used to collect data regarding the identity of the real world participant and another data collection module may collect information related to the real world participant's relative location and gestures within the real world context 14. Virtual proxy bridge 30 may include a processor, memory, a data storage device, and hardware and software peripherals to enable it to communicate with each real world user 28, access network 26, and send and receive information from data collection module 32. Virtual proxy bridge 30 includes a data interface 23 that receives real world data from data collection module 32, and a data mapping module 25 that maps the real world data received from data collection module 32 onto virtual environment 16 in order to create mixed world environment that includes the real world users 28 and the virtual environment users 20, each represented by their respective avatars. The data mapping module 25 transforms the real world data into controls signals for the avatars 40 that are to be represented in the mixed world environment. Virtual proxy bridge 30 also includes real world input module 27 for receiving output from real world computer or presentation devices.

Data collection module 32 collects and/or represents positioning and orientation data from each real world user 28 and transmits this data to virtual proxy bridge 30. For example, data collection module 32 can include one or more RFID readers and corresponding RFID tags or labels. Data collection module 32 can determine real world user identification and location information via an accelerometer, a mobile phone, Zigbee radio or other positioning techniques. Data collection module 32 may include a multi-channel video camera to capture each real world user's name tag, and via the use of one of the position-obtaining techniques described above, compute position and orientation data for each real world user 28. Data collection module 32 transmits this data to virtual proxy bridge 30. Other techniques such as signal triangulation to a wireless device may be used. Thus, data collection module 32 receives real time identity, position and orientation information from each real world user 28 and transmits this information to virtual proxy bridge 30. Orientation information such as for example gestures and mannerisms by each real world user 28 may also be captured.

Gestures by real world users 28 can be captured and converted into corresponding avatar gestures. For example, if real world user 28 points toward a presentation, this gesture can be converted into a virtual world avatar pointing with, for example, a laser pointer. Thus, real world user 28 can point at a screen and an indication, such as a dot or other digital pointer will appear on the presentation where the real world user 28 is pointing to.

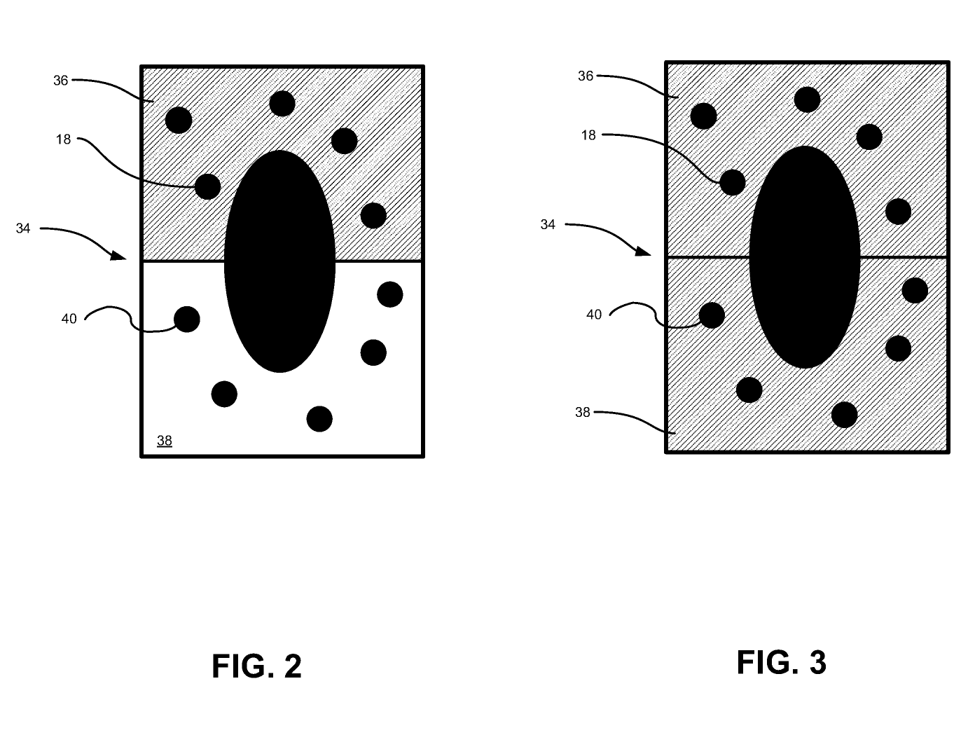

FIG. 2 depicts one exemplary embodiment of the present invention. In this embodiment, a “mixed reality” meeting, that is one that includes virtual world users 20 and real world users 28, is to take place. For example, twenty real world participants (real world users 28) are in a real world conference room. Another thirty virtual participants (virtual world users 20) are remotely participating via virtual environment 16. A logical conference room 34 is created and is shown in FIG. 2. Logical conference room 34 can be displayed on a video display that is accessible to all real world users 28 in the real world conference room as well as virtual world users 20 within virtual environment 16. Logical conference room 34 is divided into two parts—one part represents virtual portion 36 of logical conference room 34 and the other part represents real world portion 38.

Initially, a baseline identity and location for each real world user 28 is established. For example, in one embodiment, data collection module 32 is an array of passive RFID readers that are placed in various locations throughout the real world conference room such as on or just under the edge of a conference table, around the conference room door, or at the speaker's podium. In one embodiment, each real world user 28 is issued with (or already has) an RFID tag, perhaps embedded within their name tag. The RFID array reads a real world user's RFID badge or clip-on RFID tag when the real world user 28 approaches one of the RFID readers. The specific RFID reader and the identity information obtained from the RFID tag is sent to virtual proxy bridge 30. Virtual proxy bridge 30 has already stored the location within real world location 14 for each RFID reader via one of the real world user location methods previously described. Upon receipt of the RFID reader and identity information, virtual proxy bridge 30 determines the location for the particular RFID reader and uses this information plus the real world user's identity to establish a baseline location for that particular real world user 28. The real world user's location is stored and maintained starting at this baseline location.

In one embodiment, once each real world user's identity and location is established, mechanisms can be implemented to associate each real world user 28 with their voice as projected through their avatar. For example, a calibrated microphone array can be used to isolate the voice of each real world user 28 so that their voice can be associated with that particular user's avatar. In this fashion, if a user hears a voice from an avatar positioned to the listener's left, the listener will hear the voice out of his left speaker. Existing hardware systems such as Microsoft® Kinect® include microphone arrays that can be used for this purpose in accordance with the principles of the present invention.

Once each real world user's baseline location is determined, each real world user 28 can be tracked by any number of positioning techniques. For example, a video camera, such as a ceiling mounted video camera (fish eye) can be used to observe the room and locate and track each real world user 28. This information is sent to virtual proxy bridge 30. Human body detection logic (such as face detection) can be used track real world user 28 movements throughout the real world conference room.

In another embodiment, infrared (“IR”) tracking can be used. Similar to video tracking, an IR camera can be mounted on the ceiling of the conference room such that the IR camera can observe the entire room. The heat from each user's head is usually relatively warm and thus make optimal targets for the IR camera to follow. In yet another embodiment, the camera can be paired with an IR source and users 28 can wear an IR reflector somewhere on the upper surface of their bodies. In yet another embodiment, accelerometer tracking can be used. For example, accelerometers using Bluetooth®, or Wii® controllers, or other wireless communication systems, such as RF or ultrasonic tracking can also be used to approximate user motion. In another embodiment, an RFID reader can be situated at or near the conference room entrance in order to establish the identity of each user as they enter the conference room and a ceiling mounted movement and gesture detection system, such as Kinect® by Microsoft, can be used to capture movements and gestures of each identified user.

Once each real world user 28 has entered the real world conference room and a baseline has been established for their relative position and orientation within the room, virtual proxy bridge 30 then constructs an extension to real world context 12 by projecting each real world user 28 into virtual environment 16 so that their avatars 40 are visible to the virtual world users 20. In one embodiment, textures and lighting as well as other features that approximate real world context 14 are also extended to virtual world context 12.

As shown in FIG. 2, avatars 18 representing virtual world users 20 are displayed via, for example, a projector on the wall of the real-world conference room. Thus, to the local, real world uses 28 in the real-world conference room, virtual users 20 appear as remote participants via their avatars 18. As real world users 28 move around the conference room, their motions, gestures and locations are captured, tracked, translated into avatar motions, and mapped onto virtual environment 16. Thus, as shown in FIG. 3, to the virtual users 20 “attending” the conference, everyone “present” at the meeting, i.e., both virtual users 20 and real world users 28, is seen as a virtual participant via their avatars 18 and 40. In this manner, all users, whether a virtual user 20 or a real world user 28, can see each other and participate in a mixed reality meeting. Further, because each movement of real world user 28 is captured, along with their gestures, automatically, without any conscious input from the real world user 28, each real world user 28 need not be concerned with presenting separately to remote virtual world users 20 as well as to those participants physically present in the real-world conference room because their avatars 40 represent their movements within the real world conference room

Virtual proxy bridge 30 provides a mapping function for real world and virtual world coordinate spaces. The real world meeting room can be given a coordinate space, for example, 0,0,0, which represents a lower corner of the real world conference room and, for example, 1000,1000,1000, which would represent the opposite upper corner of the real world conference room. This coordinate space can be normalized into real world units. For example, a user standing 1 foot from the lower corner of the real world conference room is placed at coordinate location 1,1,0. The normalized coordinate space needs to be mapped into virtual world coordinates where the lower corner of the virtual room is at, for example, 3000,2500,0. The virtual world units can be measured in feet or some other unit value, such as designating “virtual units” in relation to real world dimensions. So, for example, 16 virtual units can equal one real world foot.

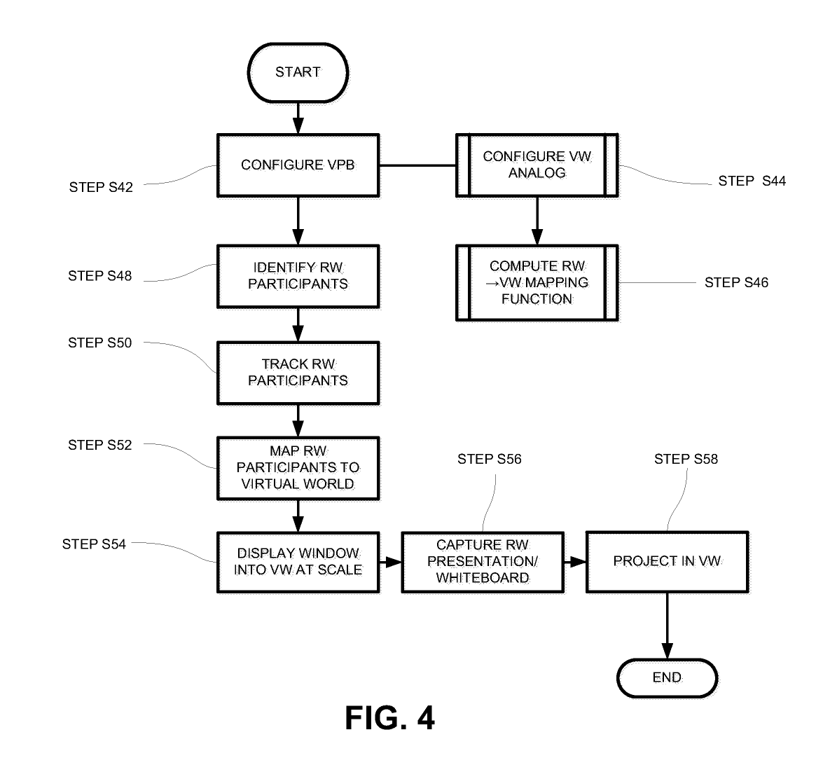

FIG. 4 is a flowchart of an exemplary process performed by virtual proxy bridge 30. At step S42, the virtual proxy bridge 30 is configured. This includes, configuring virtual world analog coordinates (step S44), and computing the real world to virtual world mapping function (step S46), as described above. At step S48, virtual proxy bridge 30 identifies real world participants by receiving from data collection module 32 information about each real world user 28. This information includes information establishing each real world user's identity and information establishing their baseline location. The movements of each real world user 28 within the real world context 14 are tracked (step S50). The captured information can also include information about real world material that is to be projected into virtual environment 16, such as PowerPoint slides.

Virtual proxy bridge 30 obtains virtual world user information from virtual environment server 22 via network 26. This information includes movements of each virtual world avatar 18 within virtual environment 16. Virtual proxy bridge 30 merges the information obtained from virtual environment server 22 and data collection module 32 The coordinates of each real world user 28 are mapped into virtual environment 16 (step S52). This data is used to place and orient each real world user 28 and their corresponding avatars 40 appropriately within virtual environment 16. The result is a mixed reality world where both virtual world users 20 and real world users 28 are represented by their respective avatars 18 and 40, respectively, on a viewing screen.

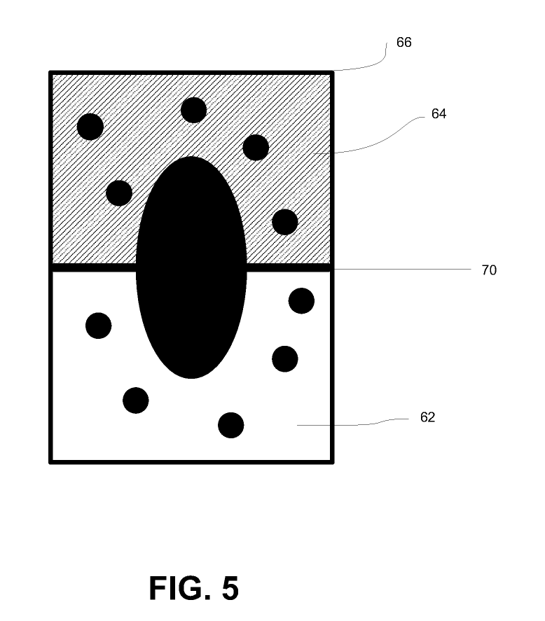

Advantageously, system 10 of the present invention allows both real world and virtual world participants to display presentations, such as slides, images on their desktops, whiteboards, and other communications in a manner visible to both real world and virtual world participants. This is accomplished by virtual proxy bridge 30 accepting computer input from the real world via, for example a High-definition Multi Media interface (“HDMI”) or Video Graphics Array (“VGA”) port, and when a real world participant is presenting or preparing a drawing, the computer output is displayed on a virtual world screen. Thus, at step S54, a window or presentation screen is displayed to the virtual world participants. This virtual world screen is visible in both the virtual world and real world as a view of the virtual world is displayed on the wall of the real world (via TV screen or projector). The view of the virtual world is selected such that the virtual world display screen is clearly visible to real world participants (as shown in FIG. 5). Thus, presentations by real world participants are captured (step S56), and projected into the virtual world where they can be viewed (step S58). In an alternate embodiment, real world participants upload their presentation materials or perform their whiteboarding using a virtual world interface

FIG. 5 is an illustration of an exemplary real world conference room layout. In this view, a real world projector screen 60 separates real world environment 62 from virtual world environment 64. A virtual world presentation screen 66 displays input such as drawing renderings. The real world renderings are viewable in both real world environment 62 and virtual world environment 64. Similarly, a view of virtual world environment 64 is viewable on real world projector screen 60.

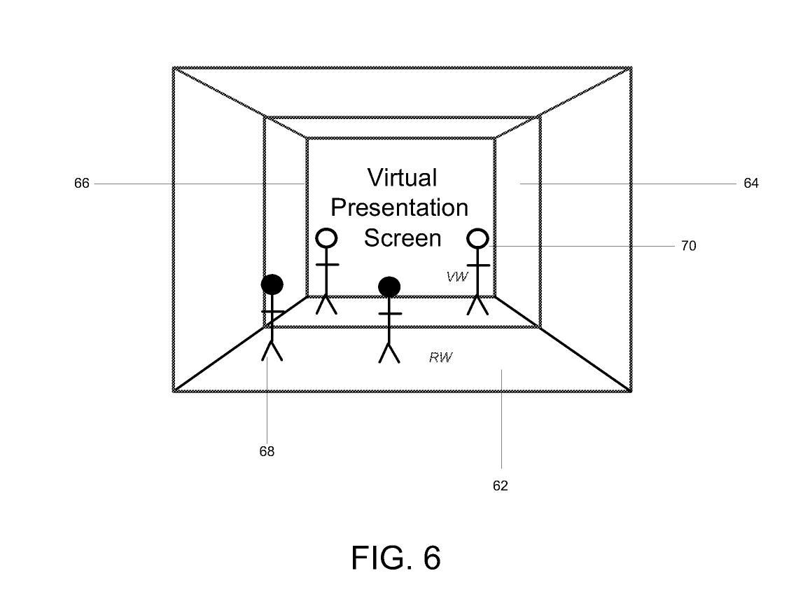

FIG. 6 illustrates how an exemplary virtual world presentation screen 66 in virtual world environment 64 would appear to real world participants 68 in the scenario discussed above. Real world participants 68 in real world environment 62 can view images being displayed on virtual world presentation screen 66 or some other type of real world display device, e.g., computer screen, TV, etc. In this manner, real world participants 68 would see images displayed on world presentation screen 66 and virtual world participants 70 on virtual world projector screen 60. Images from virtual world environment 62 appearing on screen 66 can be viewed by both virtual world participants and real world participants 68.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A method of mapping a real world user into a virtual environment, the virtual environment having a virtual environment user, the method comprising:
identifying the real world user in a real world space;
collecting real world position data from the real world user;
mapping the real world position data onto the virtual environment;
creating a mixed world environment that includes the real world user and the virtual environment user in the real world space; and
displaying the virtual environment.

2. The method of claim 1, wherein collecting real world position data from the real world user includes establishing a baseline location for each real world user within the real world space.

3. The method of claim 2, wherein collecting real world position data from the real world user includes capturing the real world user's real time movements and gestures within the real world space.

4. The method of claim 3, wherein capturing real world user movements within the real world space is performed without real world user awareness.

5. The method of claim 1, wherein the real world user and the virtual environment user are represented by avatars.

6. The method of claim 5, further comprising positioning the avatar of the real world user in the virtual environment according to the real world user's real time position in the real world space.

7. The method of claim 5, further comprising displaying the avatars of the real world user and the virtual environment user such that the avatar of the real world user is indistinguishable from the avatar of the virtual environment user.

8. The method of claim 5, wherein collecting real world data from the real world user includes capturing gestures by the real world user, wherein the method further comprises translating the gestures to the avatars of the real world user in the virtual environment.

9. The method of claim 2, wherein collecting real world position data from the real world user includes capturing movements of the real world user in the real world space by a camera.

10. The method of claim 2, wherein collecting real world position data from the real world user includes capturing movements of the real world user in the real world space by a motion detector.

11. The method of claim 2, wherein identifying the real world user in a real world space includes receiving radio frequency identification signals identifying the real world user.

12. A system for mapping a real world user onto a virtual environment, the virtual environment including a virtual environment user, the system comprising:
a data collection module identifying the real world user in a real world space and collecting real world position data from the real world user; and
a virtual proxy bridge receiving the real world position data from the data collection module and mapping the real world position data onto the virtual environment to create a mixed world environment that includes the real world user and the virtual environment user in the real world space.

13. The system of claim 12, wherein the virtual proxy bridge establishes a baseline location for the real world user within the real world space based upon the received the real world position data.

14. The system of claim 12, wherein the data collection module captures the real world user's movements and gestures within the real world space without real world user awareness.

15. The system of claim 12, wherein information presented by at least one of the real world user and the virtual environment user is viewable by at least one of the real world user and the virtual environment user in the mixed world environment.

16. The system of claim 15, wherein the virtual proxy bridge positions the avatars of the real world user in the virtual environment according to the real world user's real time position in the real world space.

17. The system of claim 15, wherein the virtual proxy bridge presents the avatars of the real world user and the virtual environment user on a viewing interface, the avatars of the real world user being indistinguishable from the avatar of the virtual environment user.

18. The system of claim 15, wherein the data collection module captures gestures by the real world user and the virtual proxy bridge translates the gestures to the avatars of the real world user in the virtual environment.

19. A virtual proxy bridge for mapping a real world user onto a virtual environment, the virtual environment including a virtual environment user, the virtual proxy bridge comprising:
a data interface receiving real world data, the real world data identifying real world user and the real world user's position in a real world space; and
a data mapping module mapping the real world data onto the virtual environment to create an extended real world environment that includes the real world user and the virtual environment user in the real world space.

20. The virtual proxy bridge of claim 19, wherein the data mapping module captures real world visual presentations and projects the presentations such that they can be viewed by at least one of the real world user and the virtual environment user.
